(19) United States
(12) Patent Application Publication
(10) Pub. No.: US 2010/0037554 A1
(43) Pub. Date: Feb. 18, 2010

(54) CABLE LOCKING DEVICE AND METHOD

(76) Inventor: Michael H.-S. Oh, Twinsburg, OH (US)

Correspondence Address: Jonathan A. Platt;Renner, Otto Boisselle & Sklar, LLP, 19th Floor, 1621 Euclid Ave., Cleveland, OH, 44115, US

(21) Appl. No.: 12/539,650

(22) Filed: Aug. 12, 2009

Related U.S. Application Data
(60) Provisional application No. 61/088,372, filed on Aug. 13, 2008.

(51) Int. Cl. E04B 1/38; F16B 39/28

(52) U.S. Cl. 52/745.21; 411/253

(57) ABSTRACT

A locking device includes a main housing with one or more plunger sets therein for gripping a cable. The plunger sets each have two or more pieces, for example plunger pieces, that are partially within a bore in the main housing. The plunger halves or pieces have teeth on inner surfaces, for gripping a cable that runs through the bore, between the plunger halves or pieces. A spring within the bore biases the plunger set to one side of the bore, a location in which the plunger halves or pieces are pressed together, causing the inner surface teeth to bite into the cable to secure the cable. A nut is threadedly connected to a threaded outer surface of the plunger halves, outside of the bore, to allow the plunger set to be moved within the bore, to allow disengagement of the cable from the teeth.

This application claims priority under 35 USC 119 from U.S. Provisional Patent Application No. 61/088,372, filed Aug. 13, 2008.

### BACKGROUND OF THE INVENTION

1. Technical Field of the Invention

The invention relates in general to cable locking devices and methods.

2. Description of the Related Art

CADDY® SPEED LINK is an example of a system that provides a means to suspend static loads from ceilings, structures, and sub-structures. Such a system is shown and described in co-owned U.S. Pat. Nos. 7,039,987, 7,150,078, and 7,346,962, which are incorporated herein by reference in their entireties.

Possible shortcomings of prior systems include: locking device is too large and too noticeable from a distance; locking device requires a key to release and adjust the cable; cable slips down in service after our locking device is installed. In addition, the current cable locking devices often do not generate enough load ratings for seismic applications.

### SUMMARY OF THE INVENTION

According to aspects of the invention, a cable locking device has one or more of the following characteristics: integral unlocking mechanism for keyless application—general and seismic applications; integral locking mechanism for safety reason—general and seismic applications; cable biting mechanism to generate higher cable load ratings for single barrel locking devices as well as seismic cable locking devices—general and seismic applications; single barrel locking device—general and seismic applications; single barrel locking device riveted with several different mounting brackets and beam clamps—general application only; single barrel locking device riveted or crimped with several different toggles—general application only; beam clamp equipped with newly developed plunger set—general application only; single barrel locking device with decking mounting or wall mounting angle bracket for general and seismic applications; and special single barrel locking devices with newly developed plunge set to hang electric conduit boxes, lighting fixtures and struts—general application only.

According to another aspect of the invention, a locking device includes: a body having a bore therein; a plunger set partially within the bore; and a spring within the bore pressing the plunger toward one end of the bore. The plunger set includes multiple plunger parts having teeth on inner surfaces for gripping a cable placed between the plunger parts.

According to yet another aspect of the invention, a method of securing a cable includes the steps of: running the cable through a bore in a housing of a locking device, and between plunger sets (pieces) that are partially in the bore; pressing against the plunger sets with a spring that is in the bore, wherein the pressing presses the plunger sets toward one another; and engaging the cable with teeth on inner surfaces of the plunger pieces.

According to still another aspect of the invention, a locking device includes: a body having a bore therein; a plunger set partially within the bore; and a spring within the bore pressing the plunger toward one end of the bore. The plunger set includes multiple plunger parts having gripping surfaces on inner surfaces for gripping a cable and or wire placed between the plunger parts.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The annexed drawings, which are not necessarily according to scale, show various aspects of the invention.

FIG. 1 is a cross-sectional view of a locking device in accordance with an embodiment of the invention, along Section 1-1 of FIG. 2.

FIG. 2 is a top view of the locking device shown in FIG. 1.

FIG. 3 is a cross-sectional detail view of part of the locking device of FIG. 1, showing engagement of a threaded nut onto the threaded neck of a plunger set.

FIG. 4 is a cross-sectional view along Section 4-4 of FIG. 2.

FIG. 5 is a detailed view of a portion of FIG. 4.

FIG. 6 is a cross-sectional view of a plunger half of the locking device of FIG. 1.

FIG. 7 is a top view of a plunger set of the locking device of FIG. 1.

FIG. 8 is a top view of the plunger set of FIG. 7, with a cable between the plunger sets.

FIG. 9 is a cross-sectional view of an alternate embodiment locking device in accordance with the present invention, a single-barrel locking device.

FIG. 10 is an oblique view of the locking device of FIG. 9 coupled to a hammer-on beam flange clamp.

FIG. 11 is an oblique view of the locking device of FIG. 9 coupled to a screw-on beam hanger.

FIG. 12 is an oblique view of the locking device of FIG. 9 coupled to a purlin clip.

FIG. 13 is an oblique view of the locking device of FIG. 9 coupled to another purlin clip.

FIG. 14 is an oblique view of the locking device of FIG. 9 coupled to a screw-on beam clamp.

FIG. 15 is an oblique view of a beam clamp in accordance with an embodiment of the invention, incorporating an integral locking device.

FIG. 16 is an oblique view of a locking device for securing a cable end, in accordance with an embodiment of the invention.

FIG. 17 is an oblique view of a first embodiment of the locking device of FIG. 9 coupled to angle bracket.

FIG. 18 is an oblique view of a second embodiment of the locking device of FIG. 9 coupled to angle bracket.

FIG. 19 is a cross-sectional view of a locking device in accordance with another embodiment of the present invention.

FIG. 20 is a cross-sectional view of a locking device in accordance with yet another embodiment of the present invention.

FIG. 21 is a cross-sectional view of a locking device in accordance with still another embodiment of the present invention.

FIG. 22 is an oblique view of one embodiment of a strut-securing locking device in accordance with the present invention.

FIG. 23 is an oblique view of another embodiment of strut-securing locking device in accordance with the present invention.

FIG. 24 is a side view of a plunger set of an alternate embodiment locking device in accordance with the present invention.

FIG. 25 is an oblique view of a plunger half of the plunger set of FIG. 24.

FIG. 26 is a sectional view of the plunger half of FIG. 25, showing a section through the bump of the plunger half.

FIG. 27 is a partial cutaway view of a portion of a locking device that includes the plunger set of FIG. 24.

FIG. 28 is a detailed view of part of FIG. 27, illustrating operation of the bump.

FIG. 29 is a partial cutaway view of a portion of a locking device that includes the plunger set of FIG. 24, with a cable installed in the locking device.

### DETAILED DESCRIPTION

In order to meet all above requirements, a locking device has any of various configurations, such as those shown in the figures and described below. Locking devices in accordance with these embodiments have characteristics such as slick and elegant shape as well as easy to grab; small envelop size; keyless (integral unlocking mechanism); fire rating (all steel parts); higher load rating capacity—such as increasing the cable contact areas using the fishhook teeth; and a simple concept with a small number of parts for a low product cost.

A locking device includes a main housing with one or more plunger sets therein for gripping a cable. The plunger sets each have two or more pieces or parts, for example plunger halves, that are partially within a bore in the main housing. The plunger halves or pieces have teeth on inner surfaces, for gripping a cable that runs through the bore, between the plunger halves or pieces. A spring within the bore biases the plunger set to one side of the bore, a location in which the plunger halves or pieces are pressed together, causing the inner surface teeth to bite into the cable to secure the cable. A nut is threadedly connected to a threaded outer surface of the plunger halves, outside of the bore, to allow the plunger set to be moved within the bore, to allow disengagement of the cable from the teeth.

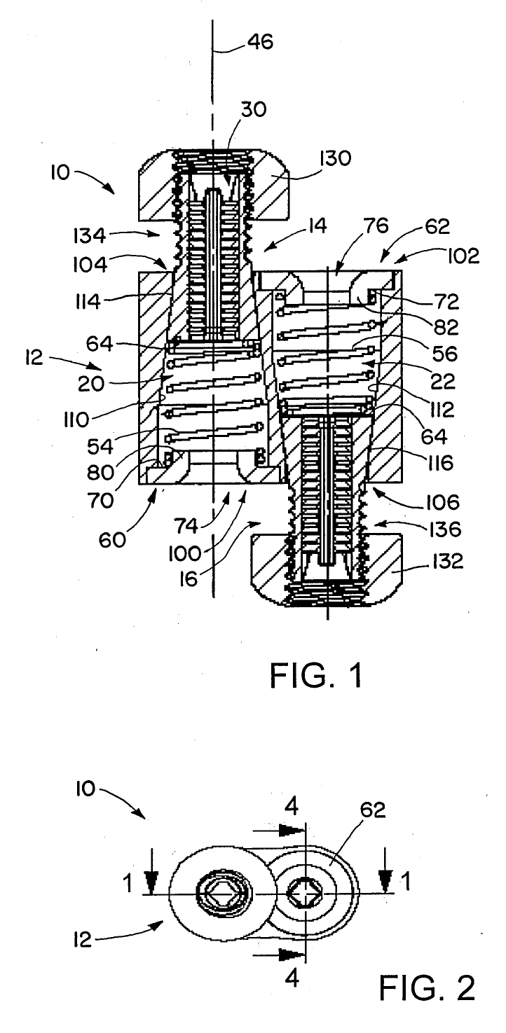

Referring to FIGS. 1-8, a double barrel locking device 10 for a loop or splice mounting is shown. The device 10 includes a main housing 12 that holds two, external threaded plunger sets 14 and 16 (also referred to herein as “plungers”) through which one or more cables pass in opposing directions. Portions of the plunger sets 14 and 16 are located within respective bores 20 and 22 in the main housing 12. Each of the plunger sets 14 and 16 consists of left and right plunger pieces of the plunger set. For example the plunger set 14 includes plunger pieces 24 and 26. More broadly, the plunger sets 14 and 16 may include two or more plunger parts or pieces, which together may be squeezed together within the bores 20 and 22 to secure or lock a cable or cables running through the bores 20 and 22, in between the plunger parts of the plunger sets 14 and 16. In the following description the plunger set 14 is described in some detail, but it will be appreciated that the plunger set 16 may have similar components and features. Moreover, the plunger pieces 24 and 26 may be substantially identical, and details and features may be described only with regard to one of the plunger halves 24 and 26.

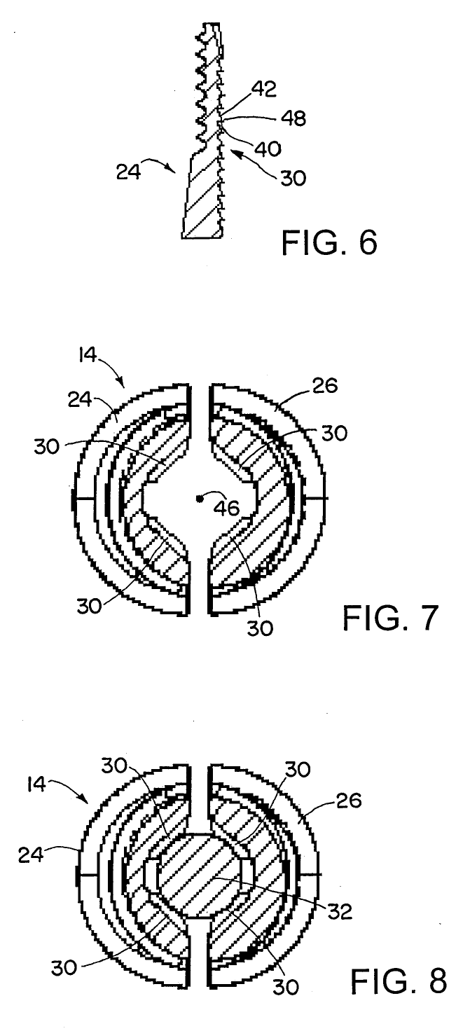

The bores 20 and 22 are internally tapered bore of the housing 12 that enclose portions of the two pieces of each of the plunger sets 14 and 16. Gripping surfaces, such as using internal fishhook teeth, such as the teeth 30, are located on inside surface of on two halves 24 and 26 of the plunger set 14. The teeth 30 are used for biting and locking a cable 32, as seen in FIG. 8. As best seen in FIG. 6, the teeth 30 may be angled in a directionally-biased way, with bottom or lower faces 40 of the teeth 30 at a different angle than top or upper faces 42 of the teeth 30. For example the bottom faces 40 may be substantially perpendicular to a central axis 46 of the plunger set 14, while the upper faces 42 may be angled at about a 40-degree angle to the axis 46. Thus each of the teeth 30 may have an angular extent of about 50 degrees. The faces 40 and 42 of the teeth 30 meet at edges 48 of the teeth 30. The different orientations of the faces 40 and 42 of the teeth 30 may allow easier movement of the cable in 32 in one direction, along the top faces 42 of the teeth 30 (in the direction which the top faces 42 are angled), than in the opposite direction, against the bottom faces 40 of the teeth 30.

The tooth edges 48 may be sharp edges configured to bite into the cable 32 when the plunger pieces 24 and 26 are pressed inward against the cable 32. As best seen in FIG. 7, the teeth 30 may have substantially straight edges, running diagonally about the plunger axis 46 as viewed from above. It will be appreciated that the teeth 30 may alternatively have different configurations, with for example different configurations of faces and edges than in the illustrated embodiment.

It will be appreciated that the available types of gripping surfaces extend beyond use of teeth. For example the gripping surfaces may include friction-enhancing textured patterns. Examples of such patterns include cross-hatched patterns of raised ridges, parallel series of raised ridges in a circumferential direction, and raised protrusions in any of a variety of patterns.

The plunger sets 14 and 16 are biased into a locking position within the bores 20 and 22 by conical compression coil springs 54 and 56, which are enclosed in the bores 20 and 22 by back plates 60 and 62. The back plates 60 and 62 are press fit and staked into the housing 12 to encase the springs 54 and 56, or alternatively may be threaded into the housing 12. The respective springs 54 and 56 are located between the plunger sets 14 and 16, and the back plates 60 and 62. On one side the springs 54 and 56 press against plunger surfaces 64 and 66 of the plunger sets 14 and 16. Alternatively, the springs 54 and 56 may press against washers on top of the parts of the plunger sets 14 and 16. On the opposite sides the springs 54 and 56 press against back plate inner surfaces 70 and 72. The back plates 60 and 62 have respective central holes 74 and 76 to allow cables or rods to pass therethrough. Inward-bent back plate lips 80 and 82 surround the holes 74 and 76 and protrude inward from the inner surfaces 70 and 72, aiding in securing the spring ends in contact with the back plate inner surfaces 70 and 72.

As noted above, the bores 20 and 22 vary in diameter from wide ends 100 and 102 to narrow ends 104 and 106. The back plates 60 and 62 close off the wide ends 100 and 102. The plunger sets 14 and 16 are located at the narrow ends 104 and 106. The springs 54 and 56 bias the plunger sets 14 and 16 to move away from the wide ends 100 and 102. There inner surfaces 110 and 112 of the bores 20 and 22 engage smooth outer surface portions 114 and 116 of the plunger halves or parts (such as the plunger halves 24 and 26) of the plunger sets 14 and 16. The surface portions 114 and 116 may have a shape that corresponds to part of the shape of the inner surfaces 110 and 112. Thus when the plunger sets 14 and 16 are pressed toward the narrow ends 104 and 106, the plunger sets 14 and 16 may be in contact with the inner surfaces 110 and 112 along a significant portion of the inner surfaces 110 and 112. The pressing of the plunger set outer surfaces 114 and 116 against the bore inner surfaces 110 and 112 causes an inward pressure against the plunger pieces, resulting in the biting of the teeth 30 into the cable 32.

Knurled nuts 130 and 132 are threaded onto the opposite ends of the plunger sets 14 and 16, serving as positive locking devices for safety reasons. The plunger sets 14 and 16 have externally threaded necks 134 and 136 on their plunger pieces, configured for engaging the internal threads of the knurled nuts 130 and 132. The externally threaded long necks 134 and 136 on two halves of each of the plunger sets 14 and 16, the knurled nuts 130 and 132, and the compression springs 54 and 56 are assembled into the tapered bores 20 and 22 of the housing 12, and create an integral unlocking mechanism. By pushing on the knurled nuts 130 and 132, the spring biasing of the plunger sets 14 and 16 is overcome. This disengages the plunger sets 14 and 16 from the narrow bore ends 104 and 106. This allows separation in a radial direction of the plunger pieces of the plunger sets 14 and 16. This disengages the teeth 30 from the cable or cables 32, allowing movement of the cable or cables 32 within the bores 20 and 22. After the cable or cables 32 are positioned as desired, the knurled nuts 130 and 132 may be threaded further along the externally threaded necks 134 and 136 of the plunger sets 14 and 16, bringing the knurled nuts 130 and 132 against the main body 12. This prevents accidental disengagement of the plunger sets 14 and 16 by accidental depression of the knurled nuts 130 and 132.

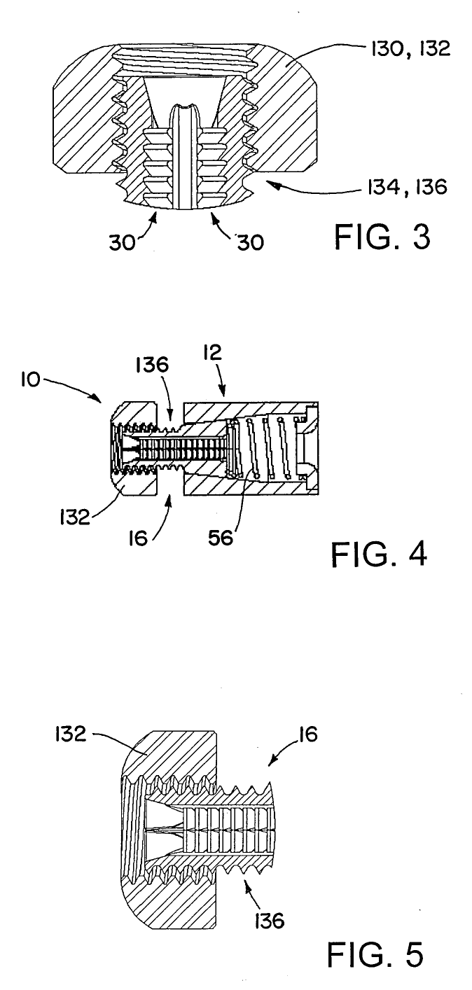

In one direction, shown in particular in FIGS. 1 and 3, the internal threads on the knurled nuts 130 and 132 always engage with the external threads on the plunger necks 134 and 136, regardless of whether the cable (or cables) 32 is installed into the plunger sets 14 and 16. In a perpendicular direction, shown in particular in FIGS. 4 and 5, the internal threads on the knurled nuts 130 and 132 do not engage with the external threads on the plunger necks 134 and 136 when the cable 32 is not installed into the plunger sets 14 and 16. However the knurled nuts' internal threads will engage with the external threads on the plunger necks 134 and 136 when the cable 32 is installed into the plunger sets 14 and 16, similar to what is shown in FIG. 3. The cable 32 pushes part of the plunger pieces to cause this threaded engagement.

When the cable 32 is/are installed into the internal tapered plunger bores 20 and 22, the cable 32 force open the two pieces of each of the plunger sets 14 and 16. At the same time, the cable 32 pushes the plunger sets 14 and 16, which in turn push the springs 54 and 56. Therefore the cable 32 pass through the internal plunger teeth 30. Whenever the cable installer stops pushing the cable after the cable 32 is passed through the internal plunger set 14/16, the internal fish hook teeth (sharp and hardened teeth) 30 on the plunger set 14/16 will instantly bite the cable 32 so it prevents the cable slip. As seen in FIGS. 6-8, the internal fish hook teeth 30 are V-shape teeth. The cable 32 is shown cutting into the teeth 30 when the cable 32 is pulled against the cable locking device 10.

Existing cable locking devices in the market use balls, pinion teeth or latch teeth. The cable load rating relies on one or two point contacts between the cable surface and the cable locking mechanism such as a ball, pinion tooth, or latch tooth.

In the device 10, the several fish hook teeth 30 on the entire length of the plunger set 14/16 are uniformly compressing to the cable surface so that it significantly reduces the maximum local stress at the first tooth. The cable load rating of this configuration generates almost two times higher than many existing other cable locking devices in the market.

After the nuts 130 and 132 are loosened and the nuts 130 and 132 are pushed in the direction of the housing 12, the cable/cables 32 will be disengaged from the plunger set 14 and 16. Therefore a user can adjust the cable height at any time without a key. As noted above, to safely secure the device 10 the nuts 130 and 132 should be tightened after the cable installation is completed.

The various parts of the locking device may be made of steel or another suitable material. Various features may be made by suitable processes such as machining or casting.

Existing double barrel locking devices have to use the factory pre-cut cable that is crimped with the hook. The single barrel locking device can use either the factory pre-cut cable crimped with hook or the spool of the cable that will cut the right length in the field.

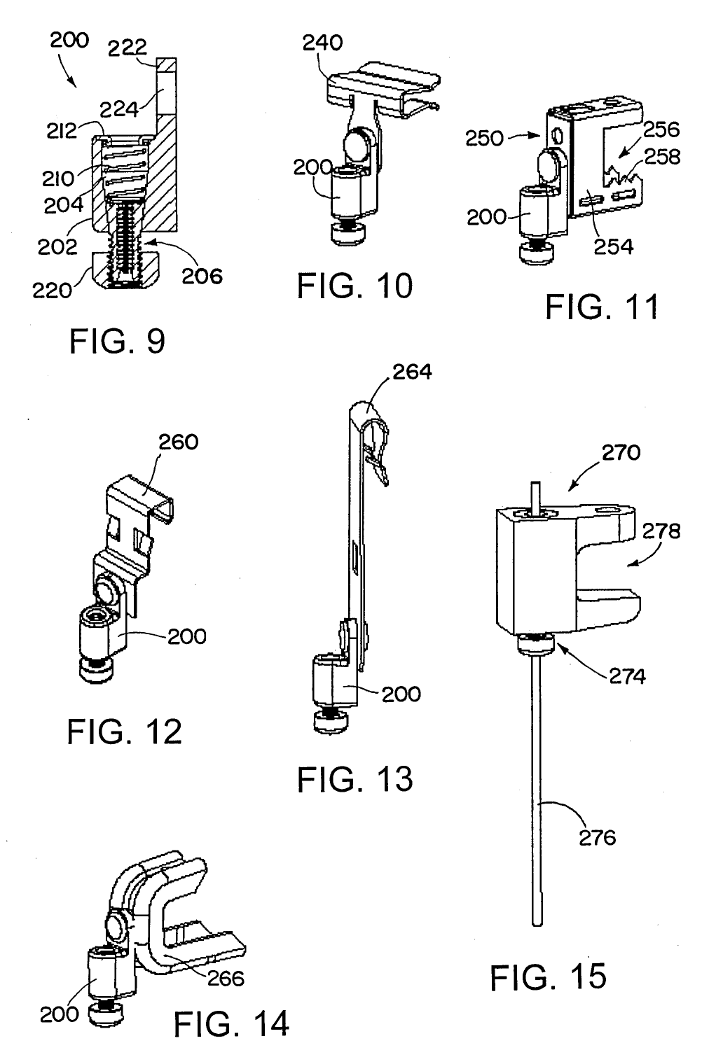

FIG. 9 shows a single-barrel cable locking device 200. The single-barrel device 200 has many of the same features as in the double-barrel device shown in FIG. 1. The device 200 has a main body 202 with a tapered bore 204. A plunger set 206 and a spring 210 are located in the tapered bore 204, retained in the tapered bore 204 by a back plate 212. The plunger set 206 has a pair of plunger pieces with teeth used for biting and holding a cable inserted in between them. A knurled nut 220 is threaded onto a neck of the plunger set 206, and used to disengage the locking of the plunger set 206. The knurled nut can be tightened up against the body 202 to secure the device 200 against disengagement. The device 200 has a tab 222 protruding from the body 202. The tab 222 has a hole 224 for receiving a fastener, such as a rivet, to couple the device 200 to any of a variety of clips, clamps, brackets, structural members, or the like.

Existing cable locking mechanisms such as the ball, pinion and latch cannot generate enough cable load ratings with 5 to 1 safety factor for a single barrel locking device. This has been a hurdle in development of a single barrel locking device. The single barrel locking device 200 can meet the current load ratings of the double barrel locking devices.

It would be advantageous to have single locking devices (like the device 200) riveted to any of several different types of mounting brackets and beam clamps. FIG. 10 shows device 200 coupled by a rivet to a hammer-on beam flange clip 240. The flange clip 240 has a generally U-shape and may be made of spring steel, having flexible top and bottom legs which spread as the clip is hammered on a flange, such as a beam flange.

In FIG. 11 the locking device 200 is shown attached to a screw-on beam hanger 250. The beam hanger 250 is sold by ERICO International Corporation of Solon, Ohio, U.S.A. under the part number BC, and also under the registered trademark CADDY®. The beam hanger clamp 250 fits beam flanges to 1.27 cm or a half inch. The beam clamp 250 has a sheet metal body 254 formed in the U-shape configuration illustrated with a bolt threaded above and projecting into an opening or mouth 256, the lower edge or jaw of which is formed by the teeth 258.

FIGS. 12 and 13 show the locking device 200 connected (by riveting) to a pair of purlin clips 260 and 264. It will be appreciated that the device 200 may be attached to a variety of shapes of purlins, such as C-purlins and Z-purlins, using a variety of well-known types of clips, such as clips that attach to flanges of the purlins.

FIG. 14 shows the locking device 200 connected to a screw-on beam clamp 266 that is configured to be installed on a beam flange edge. The beam clamp 266 may be any of a variety of screw-on beam clamps sold by ERICO International Corporation of Solon, Ohio, U.S.A., for example a beam clamp part number BC400 sold under the trademark CADDY®.

FIG. 15 shows another type of beam clamp 270, a cast beam clamp usable for clamping onto a beam flange, with an integrated cable or rod locking device 274 as part of the clamp 270. The locking device 274 may have internal workings substantially identical to those of the locking device 200 (FIG. 9). The integral locking device 274 of the clamp 270 may be used to couple a cable or rod 276 to the beam clamp 270, allowing the cable or rod 276 to be coupled to a beam that has its flange secured in an opening 278 between flanges of the clamp 270.

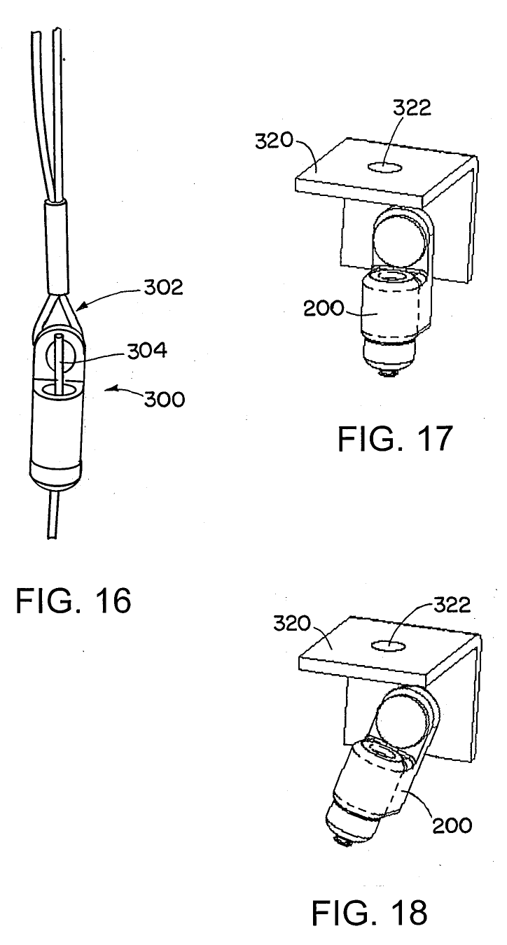

FIG. 16 shows a locking device 300 that holds a loop of cable 302 at one end, and secures a free end 304 of the cable at the other end. The locking device 300 may be used to suspend an object, such as described in co-owned U.S. Pat. No. 7,039,987. The locking device 300 may use substantially the same mechanism as the locking device 200 (FIG. 9) described above.

FIGS. 17 and 18 show the locking device 200 mounted (such as by riveting) to an angle bracket 320 having a mounting hole 322. In the configuration shown in FIG. 17 the locking device is fixedly attached to the angle bracket 320. This configuration is useful for fixed securing articles, such as to building structure.

In the configuration shown in FIG. 18 the locking device 200 is coupled to the angle bracket 320 so as to allow the locking device to hingedly move relative to the angle bracket. This configuration may be useful for applications involving seismic mountings, where it may be desirable for there to be some freedom of motion in the installation, for example to move the locking device 200 between two locations. The configuration of FIG. 18 shows the angle bracket 320 with the single barrel locking device 200, for decking mounting and wall mounting, for seismic applications. The angle bracket assembly can be rotated from two different hinge points during the assembly. Therefore the installer can find the straight cable direction by rotating these two hinges. These two hinge rotations can prevent the cable bending so that the installer does not need to de-rate the cable load rating.

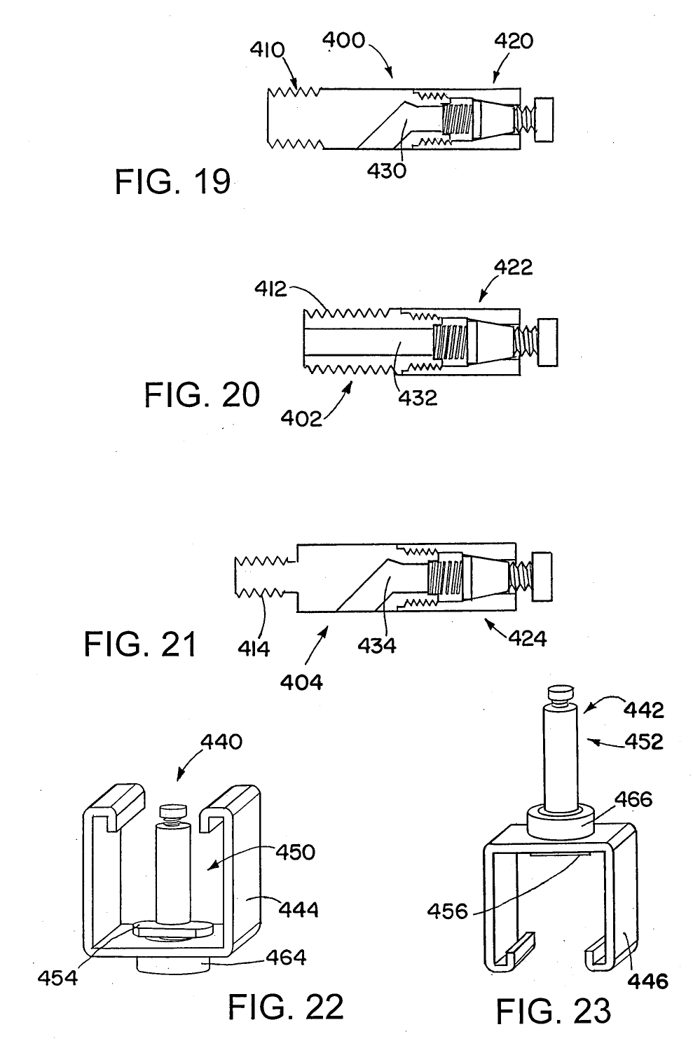

FIGS. 19-21 show locking devices 400, 402, and 404 having respective threaded ends 410, 412, and 414 for threading into building structure or other devices, such as nuts. The devices have respective locking mechanisms 420, 422, and 424, opposite the threaded ends 410, 412, and 414. The locking mechanisms 420, 422, and 424 may be configured and may operate substantially the same as that of the locking device 200 (FIG. 9), for example including plunger sets, nuts, and springs. The locking devices 400, 402, and 404 may be used to mount any of a variety of devices to building structure or other structural mechanism, for example using cables. The locking devices 400 and 404 have channels 430 and 434 out of their sides, to allow cables to pass through the locking mechanisms 420 and 424, out the sides of the devices 400 and 404. The locking device 402 has a channel 432 straight through, coming out through the threaded end 412. It will be appreciated that it may be possible to have specially designed single barrel locking devices only for hanging any suspended items, such as electric conduit boxes and lighting fixtures.

FIGS. 22 and 23 show locking devices 440 and 442 used to secure struts 444 and 446. The locking device 440 is used to secure the strut 444 in a strut-upward mounting. The locking device 442 is used to secure the strut 446 in a strut-downward position. The devices 440 and 442 have cable-securement-and-release mechanisms 450 and 452 that may be substantially similar to that of the locking device 200 (FIG. 9), allowing a cable to pass through and be secured by teeth of a plunger set. The locking devices 440 and 442 have respective plates 454 and 456 secured to their main bodies 460 and 462. Parts of the main bodies 460 and 462 are placed through holes in the struts 444 and 446, and nuts 464 and 466 are secured onto threaded portions of the main bodies 460 and 462. The securement is accomplished with the plates 454 and 456 within the enclosed part of the struts 444 and 446, and with the nuts 464 and 466 outside of the struts 444 and 446. Thus there are different configurations for the strut upward and strut downward configurations. The locking devices 440 and 442 may be used to secure struts from building structure, using cables. Alternatively the locking devices 440 and 442 may be used to secure lighting fixtures or other suspended devices to struts.

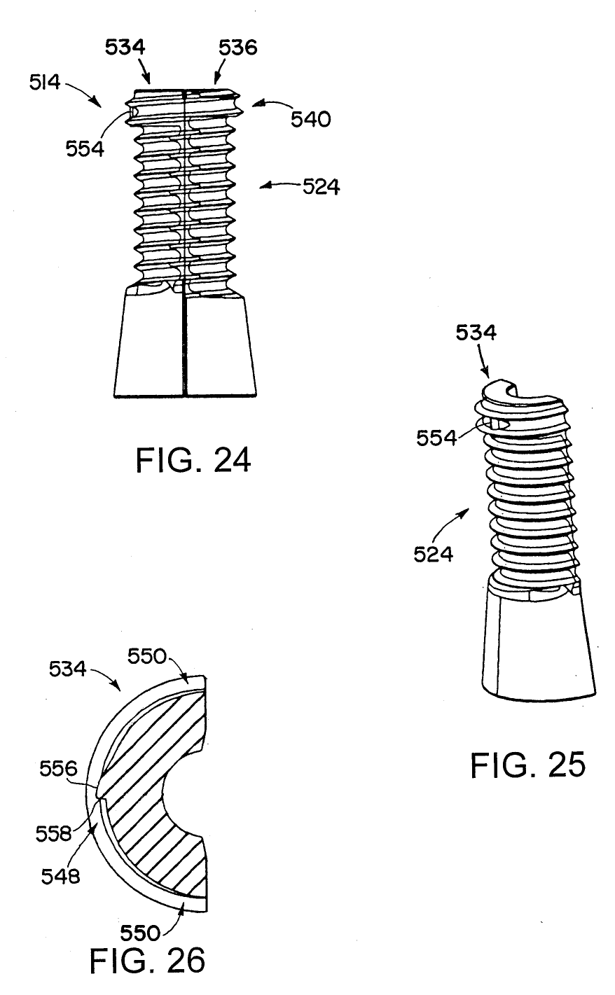

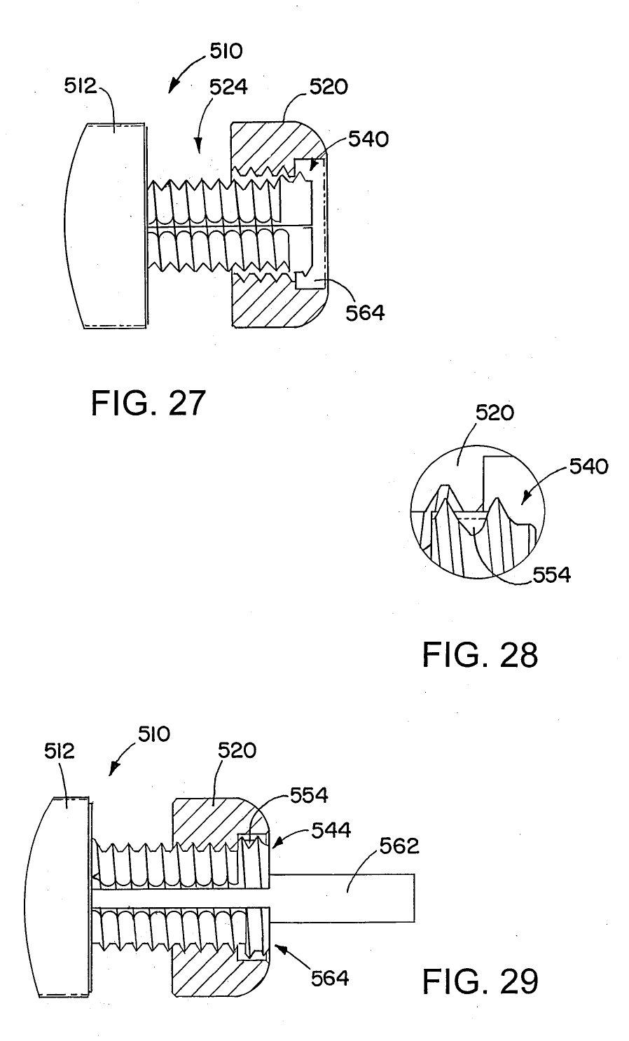

FIGS. 24-29 show an alternative configuration locking device 510, usable as either a single-barrel locking device or as part of a double-barrel locking device. The locking device 510 includes a plunger set 514 that is located in a bore of a main housing 512. The internal workings of the locking device 510 within the housing 512 may be substantially similar to those of the locking device 10 (FIG. 1) described above. The different features of the locking device 510 relate to maintaining a nut 520 on a neck 524 of the plunger set 514.

The plunger set 514 include plunger pieces 534 and 536 have an increased diameter threaded end 540 at the end of the threaded plunger set neck 524. The threads at the increased diameter end 540 are eccentric relative to the threads in the rest of the neck 524, with a center of rotation offset from that of the threads of the rest of the neck 524. Thus the threads in the end 540 have an increased diameter at the circumferential middle portion 548 of each of the plunger pieces 534 and 536, while maintaining about the same diameter as in the rest of the neck 524 at the portions 550 of the end 540 where the plunger pieces 534 and 536 come close to touching. When the nut 520 is installed on the neck 524, the increased diameter threaded end 540 may be located in a counterbore 544 of the nut 520.

In addition the plunger half 534 has a locking bump 554 in the threads of the end 540. The bump 554 has a gradual sloped surface 556 on one side, and much more sharply sloped surface 558 on the other side. As the nut 520 is threaded onto the plunger neck 524 the internal threads of the nut 520 press against the gradual slope surface 556, which allows relatively easy threading of the nut 520 onto the plunger neck 524 during assembly. However it is not so easy for the nut 520 to pass the bump 554 for disassembly, since the nut 520 must scale the sharply sloped surface 558. This requires more force, and as a practical matter the nut 520 remains locked on the plunger neck 524 against accidental disengagement, for example during transport of the assembled locking device 510.

When a cable 562 is installed in the locking device 510, the plunger pieces are forced apart to a degree. This may form a round circumference opening, versus an oval circumference without the cable placed between the parts or pieces of the plunger. This expands the increased diameter end 540, causing the threads of the end to expand outward into a recess 564 in the nut 520. This expansion makes the threads of the end 540 unable to mate with the internal threads of the nut 520, which provides a further locking mechanism for retaining the nut 520. The nut 520 is thereby prevented from loosening and disengagement from the neck 524 while the cable 562 is installed.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A locking device comprising:
a body having a bore therein;
a plunger set partially within the bore; and
a spring within the bore pressing the plunger toward one end of the bore;
wherein the plunger set includes multiple plunger parts having gripping surfaces on inner surfaces for gripping a cable and or wire placed between the plunger parts.

2. The locking device of claim 1, wherein the bore is a tapered bore that tapers from a wider end where the spring is located, to a narrower end that is the one end where the plunger set comes to rest (and protrudes from the housing).

3. The locking device of claim 2, wherein the spring pressing the plunger portions against a surface of the tapered bore produces a radially inward force urging the plunger parts toward one another.

4. The locking device of claim 3, wherein pressing the plunger set into the bore, in opposition to the force from the spring, releases the radially inward force, urging the plunger parts away from one another.

5. The locking device of claim 2, wherein the plunger parts are a pair of plunger pieces that together make up the plunger set.

6. The locking device of claim 2, wherein the plunger parts are multiple plunger pieces that together make up the plunger set.

7. The locking device of claim 2, wherein the plunger parts do not touch one another in application or at rest.

8. The locking device of claim 2, wherein the plunger parts touch one another in application or at rest.

9. The locking device of claim 2, wherein the plunger parts together have a neck that is outside of the body.

10. The locking device of claim 9, further comprising a nut on a threaded portion of the neck, for pushing the plunger set into the bore in opposition to force from the spring.

11. The locking device of claim 10, wherein the nut on the threaded portion of the neck has a counter bore therein.

12. The locking device of claim 9, wherein the neck is a threaded neck with an increased diameter threaded end that has threads that are eccentric relative to threads on the rest of the threaded neck.

13. The locking device of claim 9,
wherein the nut can be threaded past the increased diameter threaded end when no object is place between the plunger portions; and
wherein the nut cannot be threaded past the increased diameter threaded end when an object such as a cable is placed between the plunger portions to keep the plunger portions apart.

14. The locking device of claim 12,
wherein the nut can be threaded past the increased diameter threaded end when no object is place between the plunger portions; and
wherein when an object such as a cable is placed between the plunger portions form a round circumference versus an oval circumference without the cable placed between the plungers.

15. The locking device of claim 12,
wherein the nut can be threaded past the increased diameter threaded end when no object is place between the plunger portions; and
wherein when an object such as a cable is placed between the plunger portions form a round circumference with threads engaging the threads of a threadable nut that can traverse up and down the neck of the plungers.

16. The locking device of claim 12,
wherein the nut can be threaded on the plunger set with or without an object such as a cable present, past the increased diameter threaded end when no object is place between the plunger portions; and
wherein when an object such as a cable is placed between the plunger portions, the plunger portions form a round circumference with threads engaging the threads of a threadable nut that can traverse up and down the neck of the plungers.

17. The locking device of claim 12,
wherein the increased diameter threaded end includes a bump within its threads; and
wherein the bump aids in keeping the nut on the threaded neck.

18. The locking device of claim 17, wherein the bump has a shallower slope on one side and a sharper slope on an opposite side.

19. The locking device of claim 2,
further comprising a back plate in the wider end of the bore;
wherein the spring is in contact with both the back plate and either the plunger set or a washer on top of the plunger set.

20. The locking device of claim 19,
wherein the back plate has a central hole, with an inward-protruding lip around the hole; and
wherein an end of the spring fits around the lip.

21. The locking device of claim 19, wherein the back plate is press fit or threaded into the wider end of the bore.

22. The locking device of claim 1, wherein the spring is a compression spring.

23. The locking device of claim 1, wherein the gripping surfaces include teeth.

24. The locking device of claim 23, wherein the teeth are asymmetric, having faces that are sloped at different angles relative to a central axis of the plunger set.

25. A method of securing a cable, the method comprising:
running the cable through a bore in a housing of a locking device, and between plunger pieces that are partially in the bore;
pressing against the plunger pieces with a spring that is in the bore, wherein the pressing presses the plunger pieces toward one another; and
engaging the cable with teeth on inner surfaces of the plunger pieces.

26. The method of claim 25,
wherein the bore is a tapered bore; and
further comprising releasing the cable by pressing inward on the plunger set against spring force of the spring, thereby disengaging the teeth from the cable.
